(19) United States
(12) Patent Application Publication
(10) Pub. No.: US 2026/0274361 A1
(43) Pub. Date: Sep. 17, 2026

(54) MOTORCYCLE REAR RADAR INTEGRATION

(71) Applicant: Indian Motorcycle International, LLC, Medina, MN (US)

(72) Inventors: Alec S. Larson, Columbus, MN (US); Benjamin M. Comana, Bern (CH); Tyson Anderson, Lindstrom, MN (US); Jeffery M. O'Halloran, Lindstrom, MN (US); Richard J. Christoph, Minnetrista, MN (US); Ronald A. Vorndran, Osceola, WI (US); Kyle R. Kujawa, Metamora, MI (US); Michael T. Song, Maple Grove, MN (US)

(21) Appl. No.: 19/163,957

(22) PCT Filed: Mar. 27, 2024
(86) PCT No.: PCT/US2024/021703

§ 371 Date: Sep. 10, 2025

Related U.S. Application Data
(60) Provisional application No. 63/456,026, filed on Mar. 31, 2023.

(51) Int. Cl. B62J 6/045; B62J 6/056; B62J 6/24; B62J 45/41; B62J 45/42

(52) U.S. Cl. CPC B62J 6/045; B62J 6/056; B62J 6/24; B62J 45/41; B62J 45/42

(57) ABSTRACT

A rear lighting assembly for a vehicle may comprise a mount; a cover attached to the mount; a sensing unit attached to the mount and at least partially enclosed by the cover. The sensing unit may be for sensing objects behind the vehicle. A support may be attached to the mount. The support including a main body with a recess for at least partially receiving the cover and a pair of taillight assemblies. The mount may be attached to a rear fender of the vehicle and all wiring to the rear lighting assembly may be provided through a single opening in the fender.

### CROSS-REFERENCE TO RELATED APPLICATION

The present application claims the benefit of U.S. Provisional Application No. 63/456,026, entitled “MOTORCYCLE REAR RADAR INTEGRATION,” filed on Mar. 31, 2023, which is incorporated by reference herein for all purposes in its entirety.

### TECHNICAL FIELD

The present application relates generally to vehicle sensors and more particularly to mounting configurations for a rearward facing radar sensor for a motorcycle and lighting configurations using the radar sensor.

### BACKGROUND

Various vehicles, including motorcycles, include radar sensors for detecting the presence of objects within the sensing cone of the sensor. For sensing object behind the vehicle or in a blind spot, such sensors typically require a rearward facing mounting location on the vehicle that is unobstructed, which results is reduced aesthetic appeal of the vehicle as the sensor is obviously positioned for functional purposes. Thus, it would be desirable to mount a radar sensor in a compact, concealed manner that does not degrade the performance of the sensor.

### SUMMARY

According to one embodiment, the disclosure provides a rear lighting assembly for a vehicle, comprising: a mount; a cover attached to the mount; a sensing unit attached to the mount and at least partially enclosed by the cover, the sensing unit for sensing objects behind the vehicle; and a support attached to the mount, the support including a main body with a recess for at least partially receiving the cover, and a pair of taillight assemblies; wherein the mount is attached to a rear fender of the vehicle and all wiring to the rear lighting assembly is provided through a single opening in the fender. In one aspect of this embodiment, the rear lighting assembly further comprises a grommet, the grommet including a pair of openings for receiving fasteners for attaching the mount to the rear fender. In another aspect, the cover includes a pair of mounting brackets with through holes for receiving fasteners for attaching the mount to the rear fender. In another aspect, the sensing unit is a mid-range radar unit. In another aspect, the cover includes an opening and the sensing unit is disposed at least partially adjacent the opening. In still another aspect, the mount includes an upper mount for receiving the sensing unit and a lower mount configured to attach to the cover, the support and the rear fender. Another aspect further comprises a lamp assembly including a reflector and a license plate lamp, the lamp assembly being attached to the support. In another aspect, the taillight assemblies each include a hollow arm extending from a side wall of the main body, an enclosure extending from the hollow arm and a lens covering an opening in the enclosure.

In another embodiment, the present disclosure provides a system for a vehicle for indicating operating information from a rear location on the vehicle, the system comprising: a rear lighting assembly attached to a rear fender of the vehicle, the rear lighting assembly including a mount, a sensing unit attached to the mount, and a support attached to the mount and including a pair of taillight assemblies; and a pair of auxiliary lights separate from the rear lighting assembly; wherein the taillight assemblies and the auxiliary lights are controlled to indicate operating information including braking, turning, and a rear collision warning using a combination of low intensity lighting, high intensity lighting and flashing. In one aspect, the auxiliary lights are saddlebag lights. In another aspect, the taillight assemblies and the auxiliary lights indicate braking and a rear collision warning by the taillight assemblies illuminating at high intensity to indicate braking and the auxiliary lights flashing between a high intensity and off to indicate the rear collision warning. In a variant of this aspect, the auxiliary lights indicate the rear collision warning by flashing at approximately four hertz for a period of approximately three seconds. In another aspect, the taillight assemblies indicate turning by flashing between a high intensity and a low intensity. In a variant, the taillight assemblies indicate turning by flashing at a frequency within the range of approximately one to two hertz.

In still another embodiment, the present disclosure provides a system for a vehicle for indicating operating information from a rear location on the vehicle, the system comprising: a rear lighting assembly attached to a rear fender of the vehicle, the rear lighting assembly including a mount, a sensing unit attached to the mount, and a support attached to the mount and including a pair of taillight assemblies, each of the pair of taillight assemblies including an inner light portion and an outer light portion; wherein the inner light portions and the outer light portions are controlled to indicate operating information including braking, turning, and a rear collision warning using a combination of low intensity lighting, high intensity lighting and flashing. In one aspect, the inner light portions illuminate in a first color and the outer light portions illuminate in a second color that is different from the first color. In another aspect, the inner light portions and the outer light portions indicate braking and a rear collision warning by the inner light portions illuminating at high intensity to indicate braking and the outer light portions flashing between a high intensity and off to indicate the rear collision warning. In a variant of this aspect, the outer light portions indicate the rear collision warning by flashing at approximately four hertz for a period of approximately three seconds. In another aspect, the outer light portions indicate turning by flashing between a high intensity and off. In a variant, the outer light portions indicate turning by flashing at a frequency of approximately two hertz.

### BRIEF DESCRIPTION OF THE DRAWINGS

The above mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 is a perspective view of a vehicle that may incorporate the teachings of the present disclosure;

FIG. 2 is a perspective view of a portion of the vehicle of FIG. 1 including a rear lighting assembly according to one embodiment of the present disclosure;

FIG. 3 is an exploded perspective view of a rear fender of the vehicle of FIG. 1 and components of the rear lighting assembly of FIG. 2;

FIG. 4 is a side, cross-sectional view of the rear fender and rear lighting assembly depicted in FIG. 2;

FIG. 5 is a perspective view of the rear fender and rear lighting assembly depicted in FIG. 2 with certain components shown in phantom;

FIGS. 6A-6I are conceptual views of lighting configurations of a rear lighting assembly in a plurality of different modes for use in certain jurisdictions;

FIGS. 7A-7I are conceptual views of lighting configurations of another rear lighting assembly in a plurality of different modes for use in other jurisdictions; and

FIGS. 8A and 8B are perspective views of the rear lighting assembly of FIG. 2 mounted to two different vehicles.

Corresponding reference characters may indicate corresponding parts throughout the several views.

### DETAILED DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated.

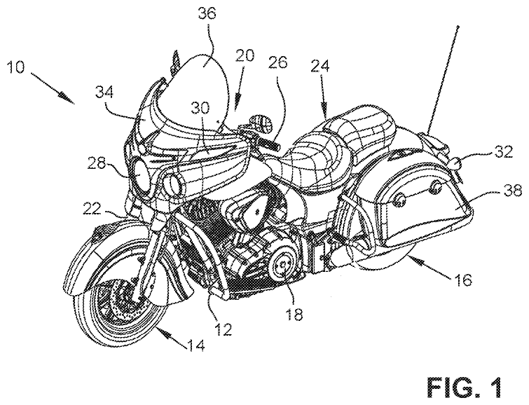

Referring now to FIG. 1, an illustrative embodiment of a two-wheeled vehicle 10 is shown. The vehicle 10 as illustrated is a touring style motorcycle although the majority of components may be used for a cruiser style motorcycle or other two or three-wheeled vehicles. The vehicle 10 generally includes a frame 12 supported by ground engaging members, namely a front ground engaging member or wheel 14 and a rear ground engaging member or wheel 16. The vehicle 10 travels relative to the ground on the front wheel 14 and the rear wheel 16. The rear wheel 16 is coupled to a power train assembly 18, to propel the vehicle 10 through rotation of the rear wheel 16. It will be appreciated that while the vehicle 10 is illustrated as a two-wheel vehicle, various embodiments of the present teachings are also operable with three, four, six, etc. wheeled vehicles.

The vehicle 10 also generally includes a steering assembly 20, front suspension 22, rear suspension (not shown), and seat 24. The steering assembly 20 includes handlebars 26 which may be moved by an operator to orient the front wheel 14 either to the left or the right. The vehicle further includes safety systems such as a front main lighting assembly 28, front turn signals 30, and rear turn signals 32. Ergonomic systems may include a front fairing 34, a windshield assembly 36 and a saddlebag assembly 38.

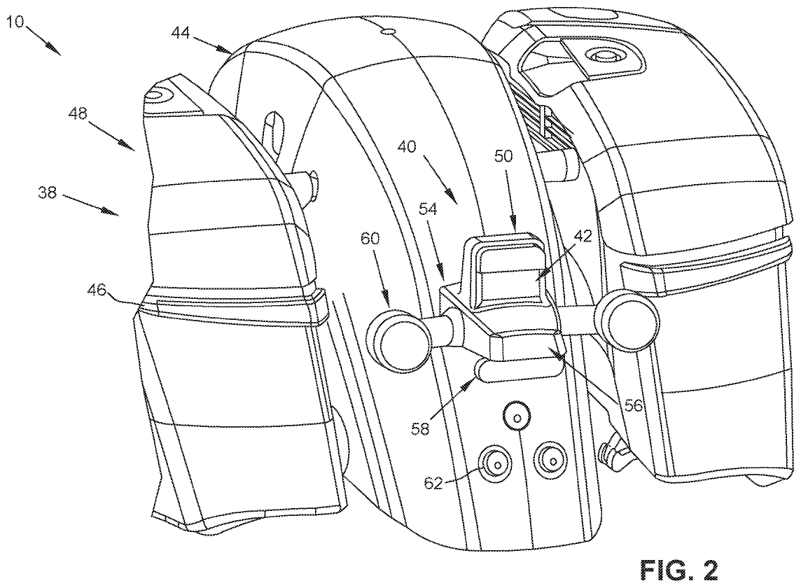

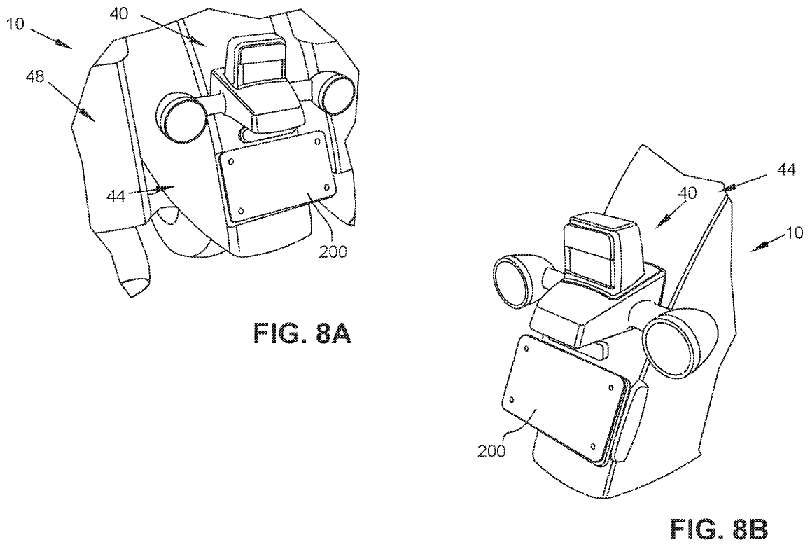

In various embodiments, the vehicle 10 may further include a rear facing sensor unit for detecting the presence of objects behind the vehicle 10. In an embodiment depicted in FIGS. 2-5, a rear lighting assembly 40 is shown incorporating a radar unit 42. It should be understood that instead a camera, LIDAR or other sensing unit could be used. Referring to FIG. 2, in one embodiment the rear lighting assembly 40 is mounted to the rear fender 44 of the vehicle 10 in a manner described further below. In certain embodiments, the rear lighting assembly 40 operates in conjunction with saddlebag lights 46 mounted to saddlebags 48 of the saddlebag assembly 38. In other embodiments, it does not. For example, FIG. 8A depicts the rear lighting assembly 40 mounted to a vehicle 10 having saddlebags 48 without saddlebag lights 46 and FIG. 8B depicts the rear lighting assembly 40 mounted to a vehicle 10 that does not have saddlebags 48. Both figures show the mounting location of a license place 200.

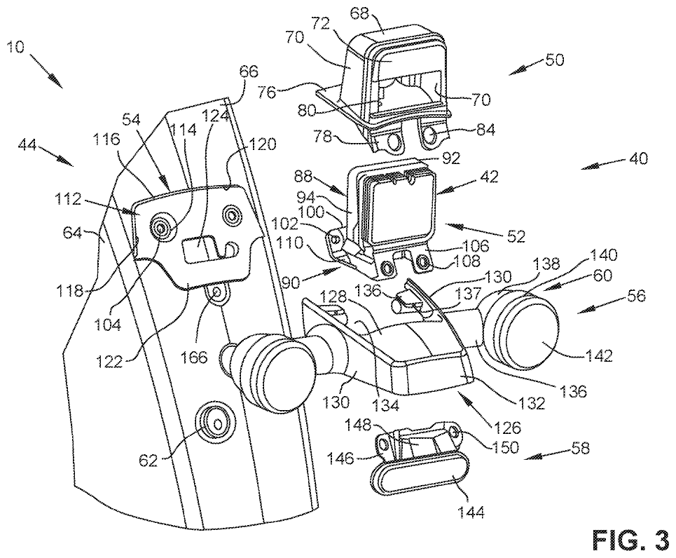

The rear lighting assembly 40 generally includes a cover 50 partially enclosing the radar unit 42, a mount 52 (FIG. 3) configured for attaching the rear lighting assembly 40 to the rear fender 44 in the manner described herein, a grommet 54, a support 56, and a license plate (“LP”) lamp assembly 58. As is further described below, the support 56 includes a pair of taillight assemblies 60. The rear fender 44 includes a plurality of license plate mounting openings 62.

Referring now to FIG. 3, the components of the rear lighting assembly 40 are described in greater detail. As shown, the rear fender 44 includes a pair of side walls 64 and a curved upper wall 66 extending between the side walls 64. The rear lighting assembly 40 is mounted to the upper wall 66 of the rear fender 44.

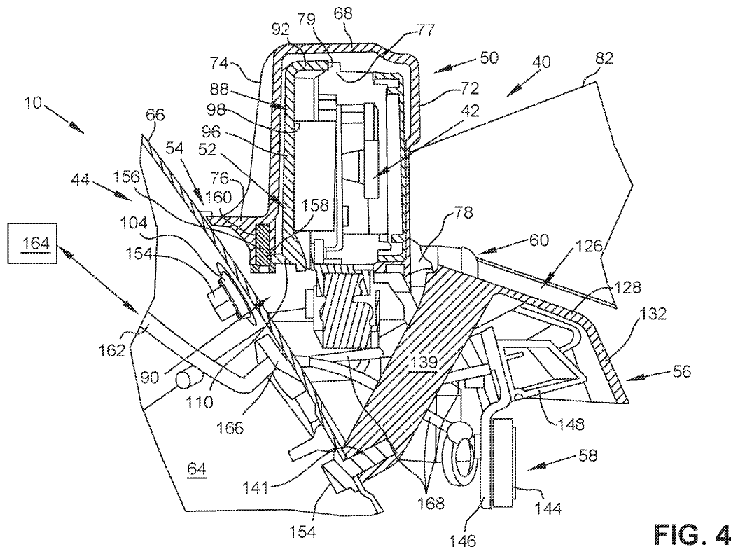

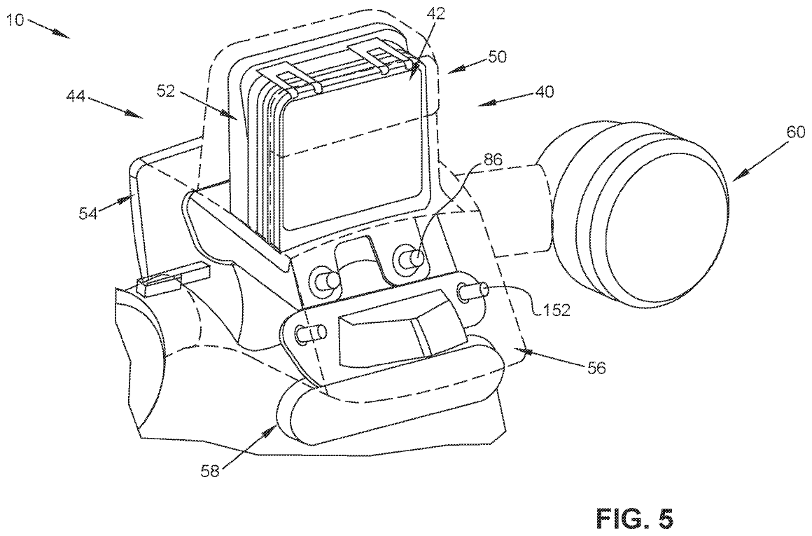

The cover 50 includes an upper wall 68, a pair of side walls 70, a outer wall 72, an inner wall 74 (FIG. 4), a mounting wall 76 and a pair of mounting brackets 78. The upper wall 68, the side walls 70, the inner wall 74 and the outer wall 72 form a partial enclosure for the radar unit 42 as is further described herein. The outer wall 72 of the cover 50 includes an opening 80 configured to permit the radar unit 42 to transmit electromagnetic wave signals that are then recaptured and used by the radar unit 42 to determine the location, velocity, etc. of an object in the path of a sensing cone 82 (FIG. 4) of the radar unit 42. Each of the mounting brackets 78 that extend from the outer wall 72 of the cover 50 include through holes 84 for receiving fasteners 86 (FIG. 5) to connect the cover 50 to the mount 52 as is further described below. In certain embodiments, the cover 50 is made of a rigid plastic material such as Acrylonitrile Butadiene Styrene or a polycarbonate plastic.

The radar unit 42 in certain embodiments may be a mid-range radar device manufactured by Bosch, such as an MRR1 Rear Mid-Range Radar device (Part No. 0203.304.971).

The mount 52 generally includes an upper radar mount 88 and a lower mount 90. The upper radar mount 88 includes an upper wall 92, a pair of side walls 94 and an inner wall 96 (FIG. 4), which together define a recess 98 (FIG. 4) that receives the radar unit 42. The lower mount 90 of the mount 52 includes an angled inner wall 100 including a pair of apertures 102 that are aligned with corresponding apertures 104 in the rear fender 44 to mount the rear lighting assembly 40 as is further described below. The lower mount 90 also includes an angled outer wall 106 including a pair of apertures 108 for receiving the fasteners 86 to connect the cover 50 to the mount 52. A lower wall 110 of the lower mount 90 extends between the angled inner wall 100 and the angled outer wall 106.

Still primarily referring to FIG. 3, the grommet 54 includes a plate 112 that generally conforms to the shape of the upper wall 66 of the rear fender 44, a pair of through holes 114 extending through the plate 112 and aligned with the apertures 104 of the upper wall 66 of the rear fender 44, an upper lip 116 that extends along the side edges 118 and the upper edge 120 of the plate 112. The upper lip 116 extends over portions of the mounting wall 76 of the cover 50 and portions of the support 56 when the rear lighting assembly 40 is mounted to the rear fender 44. The grommet 54 also includes a lower portion 122 that includes an opening 124 to allow a wiring harness 162 (FIG. 4) to be routed to the radar unit 42. In certain embodiments, the grommet 54 is made of a soft plastic material or rubber.

The support 56 of the rear lighting assembly 40 generally includes a main body 126 and the pair of taillight assemblies 60. The main body 126 includes an upper wall 128, a pair of side walls 130 and an outer wall 132. The side walls 130 and the upper wall 128 form a recess 134 that receives the mounting wall 76 of the cover 50 when the rear lighting assembly 40 is mounted to the rear fender 44 of the vehicle 10. A pair of mounting posts 135 with threaded openings 137 extend inwardly from walls 130 and align with apertures 104 of the fender 44 to mount the support 56 to the fender 44. As best shown in FIG. 4, the support 56 also includes an arm 139 with a threaded opening 141 that receives a bolt 154 that extends through the fender 44 to mount the support 56 to the fender 44. In certain embodiments, the support 56 is made of aluminum.

The taillight assemblies 60 each include a hollow arm 136 that extends laterally from a corresponding side wall 130 of the support 56. An enclosure 138 extends from each hollow arm 136 and includes an opening 140. A lens 142 is attached to the enclosure 138 to cover the opening 140 and thereby enclose the lamp components (not shown) and wiring (not shown) within the enclosure 138.

The LP lamp assembly 58 includes a reflector 144 and a license plate lamp 148 connected to a bracket 146. The bracket 146 includes a pair of openings 150 which are spaced apart to correspond to the spacing between a pair of threaded openings 152 (FIG. 5) on the support 56 to receive fasteners 153 to mount the LP lamp assembly 58 to the support 56.

Referring now to FIGS. 4 and 5, the rear lighting assembly 40 is shown (in cross-section) mounted on the rear fender 44 of the vehicle 10. The cover 50 is attached to the mount 52 using fasteners 156 that extend through openings 158 formed in the lower wall 110 of the lower mount 90 and into threaded openings 160 formed into the mounting wall 76 of the cover 50. The radar unit 42 is connected to the mount 52 via a ridge 77 that clips into an opening 79 on the upper wall 92 of the bracket 88. As shown, fasteners 154 such as bolts extend through the apertures 104 of the rear fender 44, through the through holes 114 in the plate 112 of the grommet 54, and through the apertures 102 of the angled inner wall 100 of the lower mount 90 of the mount 52. In this manner, the support 56 is connected to the fender 44, sandwiching the mount 52 between the support 56 and the fender 44.

As shown in FIG. 4, a wiring harness 162 connected on one end to a controller 164 extends through a routing hole 166 formed through the rear fender 44. The wiring harness 162 includes a plurality of wires 168 that connect to the radar unit 42, the taillight assemblies 60 and the LP lamp assembly 58 to provide power and control signals and receive monitoring signals from the radar unit 42. The controller 164 controls operation of the taillight assemblies 60 and, in certain embodiments, the saddlebag lights 46 in a manner described below. The monitoring signals from the radar unit 42 are used by the controller 164 to control a display (not shown) to notify a driver of the vehicle 10 of the presence of objects behind the vehicle 10 in a manner described in detail in U.S. Patent Publication No. 2022/169,273, the entire disclosure of which being expressly incorporated herein by reference.

In certain embodiments, the manner in which the controller 164 controls the operation of the taillight assemblies 60 and the saddlebag lights 46 is dependent upon the intended jurisdiction of use of the vehicle 10. Regulations regarding vehicle lighting vary from location to location and with regard to rear lighting indications for braking, turning (or direction indicators), hazards, and rear collision warnings (“RCW”), the regulations are different in North America and certain foreign jurisdictions, for example. As one example, it is permissible in North America to use the saddlebag lights 46 for indicating an RCW, while in certain international markets it is not.

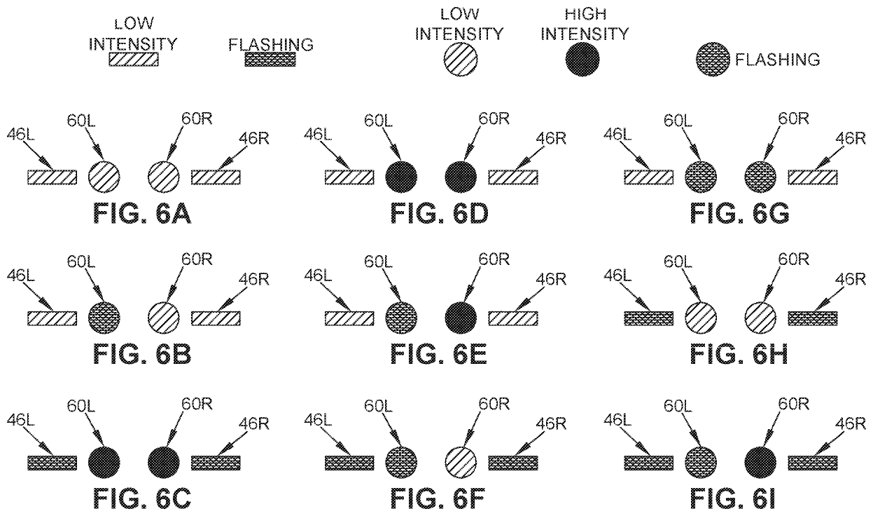

Referring now to FIGS. 6A-6I, lighting notification combinations using rear lighting for use in North America is shown. It should be understood that while the examples are described with reference to the taillight assemblies 60 and the saddlebag lights 46 described above, the notification scheme may be used with other lighting configurations. A key regarding the intensity (e.g., low or high) and state (e.g., flashing or solid (not indicated as flashing)) for the taillight assemblies 60 and the saddlebag lights 46 is provided at the top of the figures. FIG. 6A depicts the lights in a normal operating mode, such as when the vehicle 10 is simply cruising forward at a substantially constant speed. In this mode, the left saddlebag light 46L, the left taillight assembly 60L, the right saddlebag light 46R and the right taillight assembly 60R are all controlled by the controller 164 to illuminate at a low intensity. In all of the modes depicted in FIGS. 6A-6I, the taillight assemblies 60 and the saddlebag lights 46 are configured to illuminate in a red color (albeit at different intensities and different states).

FIG. 6B depicts the lights in a turn signal or direction indicator mode, wherein the taillight assembly 60L is controlled to flash between a high intensity and a low intensity while the remainder of the lights are illuminated at a low intensity. In one example, when the taillight assemblies 60 described herein are flashing, they are controlled by the controller 164 to flash between high intensity and low intensity at a rate of approximately 1 to 2 hertz.

FIG. 6C depicts the lights in a combination of a RCW and braking mode, wherein both saddlebag lights 46L, 46R are controlled by the controller 164 to flash at a high intensity while both taillight assemblies 60L, 60R are controlled to illuminate at a high intensity. In one example, when the saddlebag lights 46 described herein are flashing, they are controlled by the controller 164 to flash between high intensity and off at a rate of approximately 4 hertz for approximately 3 seconds.

FIG. 6D depicts the lights in a braking mode, wherein the taillight assemblies 60L, 60R are controlled to illuminate at high intensity and the saddlebag lights are controlled to illuminate at low intensity. FIG. 6E depicts the lights in a combination of a braking and direction indicator mode, wherein the left taillight assembly 60L is controlled to flash (indicating a left turn) and the right taillight assembly 60R is controlled to illuminate at a high intensity (indicating braking). The saddlebag lights 46L, 46R are illuminated at a low intensity.

FIG. 6F depicts the lights in a combination of a RCW and direction indicator mode, wherein the saddlebag lights 46L, 46R are flashing (providing a RCW indication), the left taillight assembly 60L is flashing (indicating a left turn) and the right taillight assembly 60R is illuminated at low intensity.

FIG. 6G depicts the lights in a hazard mode, wherein the taillight assemblies 60L, 60R are flashing and the saddlebag lights 46L, 46R are illuminated at low intensity. In certain embodiments, the hazard mode overrides braking and direction indicator lighting.

FIG. 6H depicts the lights in a RCW mode, wherein the saddlebag lights 46L, 46R are both flashing to indicate potentially to a driver behind the vehicle 10 that the driver's vehicle is too close to the vehicle 10. In this example, the vehicle 10 is otherwise not braking, turning or indicating a hazard, so the taillight assemblies 60L, 60R are illuminated at a low intensity.

Finally, FIG. 6I depicts the lights in a combination of a RCW, braking and direction indicator mode, wherein the saddlebag lights 46L, 46R are flashing (providing a RCW indication), the left taillight assembly 60L is flashing (indicating a left turn) and the right taillight assembly 60R is illuminated at a high intensity (indicating braking).

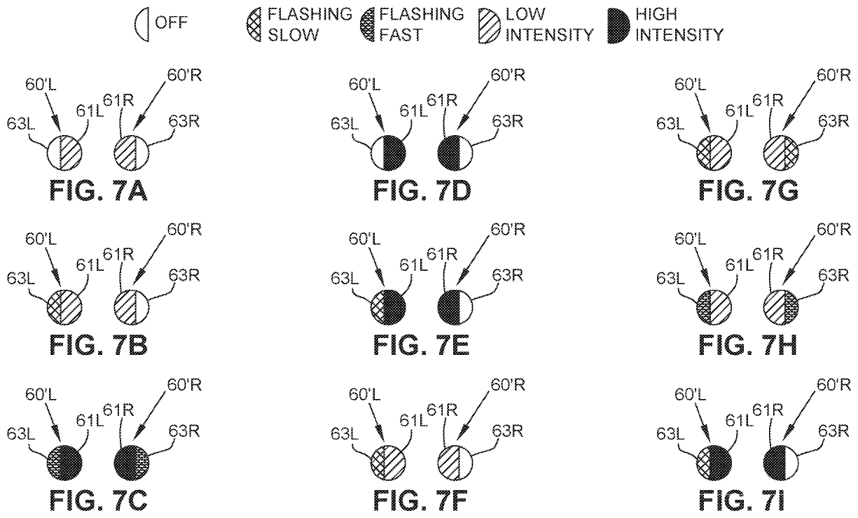

Referring now to FIGS. 7A-7I, lighting notification combinations using taillight assemblies 60′ for use in certain international markets are shown. A key regarding the intensity (e.g., low or high) and state (e.g., flashing or solid (not indicated as flashing)) for the taillight assemblies 60′ is provided at the top of the figures. In this embodiment, the taillight assemblies 60′ include inner light portions 61 and outer light portions 63. The inner light portions 61 function in substantially the same manner as the taillight assemblies 60 described above, and the outer light portions 63 function in substantially the same manner as the saddlebag lights 46 described above.

FIG. 7A depicts the lights in a normal operating mode, such as when the vehicle 10 is simply cruising forward at a substantially constant speed. In this mode, the outer light portions 63L, 63R are off and the inner light portions 61L, 61R are illuminated at a low intensity. In all of the modes depicted in FIGS. 7A-7I, the inner light portions 61 of the taillight assemblies 60′ are configured to illuminate in a red color (albeit at different intensities) and the outer light portions 63 are configured to illuminate in an amber color (albeit at different flashing speeds).

FIG. 7B depicts the lights in a turn signal or direction indicator mode, wherein the left outer light portion 63L is controlled to flash between a high intensity and off at a relatively slow rate of approximately 2 hertz (hereinafter, “slow flash”) to indicate a left turn. The right outer light portion 63R remains off, and the inner light portions 61L, 61R are illuminated at a low intensity.

FIG. 7C depicts the lights in a combination of a RCW and braking mode, wherein both of the outer light portions 63L, 63R are controlled to flash between a high intensity and off at a relatively fast rate of approximately 4 hertz for approximately 3 seconds (hereinafter, “fast flash”) to indicate a RCW. The inner light portions 61L, 61R are controlled to illuminate at a high intensity to indicate braking.

FIG. 7D depicts the lights in a braking mode, wherein the inner light portions 61L, 61R are controlled to illuminate at high intensity (indicating braking) and the outer light portions 63L, 63R are off. FIG. 7E depicts the lights in a combination of a braking and direction indicator mode, wherein the left outer light portion 63L is controlled to slow flash (indicating a left turn) and the right outer light portion 63R is off. The inner light portions 61L, 61R are controlled to illuminate at a high intensity (indicating braking).

FIG. 7F depicts the lights in a combination of a RCW and direction indicator mode. In this embodiment, the RCW lighting is not active when a direction indicator is being provided. Accordingly, the left outer light portion 63L is controlled to slow flash (indicating a left turn) while the right outer light portion 63R remains off. The inner light portions 63L, 63R are illuminated at a low intensity.

FIG. 7G depicts the lights in a hazard mode, wherein the inner light portions 61L, 61R are illuminated at a low intensity and the outer light portions 61L, 61R are controlled to slow flash (indicating a hazard).

FIG. 7H depicts the lights in a RCW mode, wherein the outer light portions 63L, 63R are controlled to fast flash to indicate potentially to a driver behind the vehicle 10 that the driver's vehicle is too close to the vehicle 10. In this example, the vehicle 10 is otherwise not braking, turning or indicating a hazard, so the inner light portions 61L, 61R are illuminated at a low intensity.

Finally, FIG. 7I depicts the lights in a combination of a RCW, braking and direction indicator mode. In this embodiment, the RCW lighting is not activated because a direction indicator is being provided. Accordingly, the left outer light portion 63L is controlled to slow flash (indicating a left turn) while the right outer light portion 63R is off. The inner light portions 61L, 61R are illuminated at a high intensity (indicating braking).

The following items are further variations and examples of the embodiments described with reference to the figures.
Example 1. A rear lighting assembly for a vehicle may comprise a mount. The rear lighting assembly may further comprise a cover attached to the mount. The rear lighting assembly may further comprise a sensing unit attached to the mount and at least partially enclosed by the cover. The sensing unit may be for sensing objects behind the vehicle. The rear lighting assembly may further comprise a support attached to the mount. The support may include a main body with a recess for at least partially receiving the cover. The support may further include a pair of taillight assemblies. The mount may be attached to a rear fender of the vehicle. All or at least part of the wiring to the rear lighting assembly may be provided through a single opening in the fender.
Example 2. The rear lighting assembly of Example 1, may further comprise a grommet. The grommet may include a pair of openings for receiving fasteners for attaching the mount to the rear fender.
Example 3. The rear lighting assembly of Example 1, wherein the cover may include a pair of mounting brackets with through holes for receiving fasteners for attaching the mount to the rear fender.
Example 4. The rear lighting assembly of Example 1, wherein the sensing unit may be a mid-range radar unit.
Example 5. The rear lighting assembly of Example 1, wherein the cover may include an opening. The sensing unit may be disposed at least partially adjacent the opening.
Example 6. The rear lighting assembly of Example 1, wherein the mount may include an upper mount for receiving the sensing unit and/or a lower mount configured to attach to the cover, the support and the rear fender.
Example 7. The rear lighting assembly of Example 1, may further comprise a lamp assembly. The lamp assembly may include a reflector and/or a license plate lamp. The lamp assembly may be attached to the support.
Example 8. The rear lighting assembly of Example 1, wherein the taillight assemblies may each include a hollow arm extending from a side wall of the main body. An enclosure may be extending from the hollow arm. A lens may be covering an opening in the enclosure.
Example 9. A system for a vehicle for indicating operating information from a rear location on the vehicle may comprise a rear lighting assembly attached to a rear fender of the vehicle. The rear lighting assembly may include a mount, a sensing unit attached to the mount, and a support attached to the mount. The support may include a pair of taillight assemblies. The rear lighting assembly may further comprise a pair of auxiliary lights separate from the rear lighting assembly. The taillight assemblies and the auxiliary lights may be controlled to indicate operating information. The operating information may include one or more of braking, turning, and a rear collision warning using a combination of low intensity lighting, high intensity lighting and flashing.
Example 10. The system of Example 9, wherein the auxiliary lights may be saddlebag lights.
Example 11. The system of Example 9, wherein the taillight assemblies and the auxiliary lights may indicate braking and a rear collision warning by the taillight assemblies illuminating at high intensity to indicate braking and the auxiliary lights flashing between a high intensity and off to indicate the rear collision warning.
Example 12. The system of Example 11, wherein the auxiliary lights may indicate the rear collision warning by flashing at approximately four hertz for a period of approximately three seconds.
Example 13. The system of Example 9, wherein the taillight assemblies may indicate turning by flashing between a high intensity and a low intensity.
Example 14. The system of Example 13, wherein the taillight assemblies may indicate turning by flashing at a frequency within the range of approximately one to two hertz.
Example 15. A system for a vehicle for indicating operating information from a rear location on the vehicle may comprise a rear lighting assembly attached to a rear fender of the vehicle. The rear lighting assembly may include a mount, a sensing unit attached to the mount, and/or a support attached to the mount. The support may include a pair of taillight assemblies. Each of the pair of taillight assemblies may include an inner light portion and an outer light portion. The inner light portions and the outer light portions may be controlled to indicate operating information. The operating information may include braking, turning, and a rear collision warning using a combination of low intensity lighting, high intensity lighting and flashing.
Example 16. The system of Example 15, wherein the inner light portions may illuminate in a first color and the outer light portions illuminate in a second color that is different from the first color.
Example 17. The system of Example 15, wherein the inner light portions and the outer light portions may indicate braking and a rear collision warning by the inner light portions illuminating at high intensity to indicate braking and the outer light portions flashing between a high intensity and off to indicate the rear collision warning.
Example 18. The system of Example 17, wherein the outer light portions may indicate the rear collision warning by flashing at approximately four hertz for a period of approximately three seconds.
Example 19. The system of Example 15, wherein the outer light portions may indicate turning by flashing between a high intensity and off.
Example 20. The system of Example 19, wherein the outer light portions may indicate turning by flashing at a frequency of approximately two hertz.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A rear lighting assembly for a vehicle, comprising:
a mount;
a cover attached to the mount;
a sensing unit attached to the mount and at least partially enclosed by the cover, the sensing unit for sensing objects behind the vehicle; and
a support attached to the mount, the support including a main body with a recess for at least partially receiving the cover, and a pair of taillight assemblies;
wherein the mount is attached to a rear fender of the vehicle and all wiring to the rear lighting assembly is provided through a single opening in the fender.

2. The rear lighting assembly of claim 1, further comprising a grommet, the grommet including a pair of openings for receiving fasteners for attaching the mount to the rear fender.

3. The rear lighting assembly of claim 1, wherein the cover includes a pair of mounting brackets with through holes for receiving fasteners for attaching the mount to the rear fender.

4. The rear lighting assembly of claim 1, wherein the sensing unit is a mid-range radar unit.

5. The rear lighting assembly of claim 1, wherein the cover includes an opening and the sensing unit is disposed at least partially adjacent the opening.

6. The rear lighting assembly of claim 1, wherein the mount includes an upper mount for receiving the sensing unit and a lower mount configured to attach to the cover, the support and the rear fender.

7. The rear lighting assembly of claim 1, further comprising a lamp assembly including a reflector and a license plate lamp, the lamp assembly being attached to the support.

8. The rear lighting assembly of claim 1, wherein the taillight assemblies each include a hollow arm extending from a side wall of the main body, an enclosure extending from the hollow arm and a lens covering an opening in the enclosure.

9. A system for a vehicle for indicating operating information from a rear location on the vehicle, the system comprising:
a rear lighting assembly attached to a rear fender of the vehicle, the rear lighting assembly including a mount, a sensing unit attached to the mount, and a support attached to the mount and including a pair of taillight assemblies; and
a pair of auxiliary lights separate from the rear lighting assembly;
wherein the taillight assemblies and the auxiliary lights are controlled to indicate operating information including braking, turning, and a rear collision warning using a combination of low intensity lighting, high intensity lighting and flashing.

10. The system of claim 9, wherein the auxiliary lights are saddlebag lights.

11. The system of claim 9, wherein the taillight assemblies and the auxiliary lights indicate braking and a rear collision warning by the taillight assemblies illuminating at high intensity to indicate braking and the auxiliary lights flashing between a high intensity and off to indicate the rear collision warning.

12. The system of claim 11, wherein the auxiliary lights indicate the rear collision warning by flashing at approximately four hertz for a period of approximately three seconds.

13. The system of claim 9, wherein the taillight assemblies indicate turning by flashing between a high intensity and a low intensity.

14. The system of claim 13, wherein the taillight assemblies indicate turning by flashing at a frequency within the range of approximately one to two hertz.

15. A system for a vehicle for indicating operating information from a rear location on the vehicle, the system comprising:
a rear lighting assembly attached to a rear fender of the vehicle, the rear lighting assembly including a mount, a sensing unit attached to the mount, and a support attached to the mount and including a pair of taillight assemblies, each of the pair of taillight assemblies including an inner light portion and an outer light portion;
wherein the inner light portions and the outer light portions are controlled to indicate operating information including braking, turning, and a rear collision warning using a combination of low intensity lighting, high intensity lighting and flashing.

16. The system of claim 15, wherein the inner light portions illuminate in a first color and the outer light portions illuminate in a second color that is different from the first color.

17. The system of claim 15, wherein the inner light portions and the outer light portions indicate braking and a rear collision warning by the inner light portions illuminating at high intensity to indicate braking and the outer light portions flashing between a high intensity and off to indicate the rear collision warning.

18. The system of claim 17, wherein the outer light portions indicate the rear collision warning by flashing at approximately four hertz for a period of approximately three seconds.

19. The system of claim 15, wherein the outer light portions indicate turning by flashing between a high intensity and off.

20. The system of claim 19, wherein the outer light portions indicate turning by flashing at a frequency of approximately two hertz.
